(19) United States
(12) Patent Application Publication
(10) Pub. No.: US 2015/0064314 A1
(43) Pub. Date: Mar. 5, 2015

(54) SYSTEM AND METHOD OF MONITORING AND ADJUSTING A TEMPERATURE OF AN OBJECT

(71) Applicants: David Briden Manuel, Bellevue, WA (US); Matthew Alexander Manuel, San Rafael, CA (US)

(72) Inventors: David Briden Manuel, Bellevue, WA (US); Matthew Alexander Manuel, San Rafael, CA (US)

(21) Appl. No.: 14/468,641

(22) Filed: Aug. 26, 2014

Related U.S. Application Data
(60) Provisional application No. 61/870,514, filed on Aug. 27, 2013.

(51) Int. Cl. A47J 27/62; A23L 1/01; G06F 17/30

(52) U.S. Cl. CPC A47J 27/62; G06F 17/3053; G06F 17/30867; G06F 17/3064; A23L 1/01; A23V 2002/00
USPC 426/231; 707/731; 99/326

(57) ABSTRACT

A method includes receiving a food item type of a food item to be cooked, a cooking appliance type of a cooking appliance for cooking the food item, a doneness and a temperature of the food item at a server, performing a search of a database stored in a memory of the server, and determining a suggested cooking set temperature and a suggested cooking duration, the database comprising food item type data, cooking appliance data, food item temperature data and doneness data stored in association with cooking set temperature data and cooking duration data, sending, from the server, a suggested cooking set temperature and a suggested cooking time.

### TECHNICAL FIELD

The present disclosure relates to systems and methods of generating and using temperature information of objects in order to monitor and adjust the object temperature using information collected from other objects.

### BACKGROUND

Cooking a food item to a desired doneness is typically achieved through trial and error for different types of food and cooking appliances. Differences between types of cooking appliances, brands of cooking appliances, models of cooking appliances, location of food items inside the cooking appliance and outside environments, for example, may affect the cooking time for achieving the desired doneness.

Similarly, defrosting or heating of a food item is achieved through experience with particular food items at particular defrosting or heating temperatures. When defrosting, errors in defrosting time estimation can put individuals at risk of food poisoning.

Therefore, greater predictability and improved results in preparation of food items is desirable.

### SUMMARY

In an aspect of the present disclosure, there is provided a method comprising: receiving and storing in a database at a server, first inputs comprising: a food item type of a food item to be cooked, a cooking appliance type of a cooking appliance for cooking the food item and a doneness; receiving and storing in the database at the server at a first time, second inputs comprising: a temperature of the food item; performing a search of a database stored in a memory of the server, and determining a suggested cooking set temperature and a suggested cooking duration, the database comprising food item type data, cooking appliance data, food item temperature data and doneness data stored in association with cooking set temperature data and cooking duration data; sending, from the server, a suggested cooking set temperature and a suggested cooking time; when a cooking set temperature is the suggested cooking set temperature, receiving at the server at a later time, the second inputs and storing the second inputs in the database in association with the food item type, the cooking appliance type and the cooking set temperature; and in response to receiving the second inputs, performing another search of the database and sending, from the server, one of: a subsequent suggested cooking set temperature, a subsequent suggested cooking time and both a subsequent suggested cooking set temperature and a subsequent suggested cooking time; wherein the food item type data, the cooking appliance data, the cooking set temperature data and the cooking duration data of the database were received from a plurality of devices.

In another aspect of the present disclosure, there is provided a method of defrosting or heating a food item comprising: receiving, at a processor of a server, first inputs comprising a food item type and a surrounding temperature; receiving at the processor, second inputs comprising: a temperature of the food item, and storing the temperature of the food item in the database in association with the food item type, and the surrounding temperature; performing a search of a database stored in a memory of the server, and determining a suggested time, the database comprising food item type data stored in association with room temperature data, food item temperature data and duration data; sending, from the server, the suggested time; wherein the food item type data, surrounding temperature data, and duration data of the database were received from a plurality of devices, the devices having wireless communication capability.

In yet another aspect of the present disclosure, there is provided a method of monitoring and adjusting a temperature of an object comprising: receiving, at a processor of an electronic device, an object type, a current temperature of the object and a type of heating or cooling device; sending the object type, the current temperature of the object and the type of heating or cooling device to a server, the object type, the current temperature of the object and the type of heating or cooling device being stored on the server; and receiving, at the processor of the electronic device, a suggested set temperature for the heating or cooling device to achieve a suggested final temperature for the object type.

In still another aspect of the present disclosure, there is provided a system for monitoring and adjusting a temperature of an object comprising: a portable electronic device for receiving first inputs comprising: a food item type of a food item to be cooked, a cooking appliance type of a cooking appliance for cooking the food item and a doneness, the portable electronic device for sending the first inputs to a server; a temperature probe in communication with the portable electronic device, the temperature probe generating second inputs comprising a temperature of the food item, the temperature probe sending the second inputs to the server at more than one time over a cooking duration; a database stored in a memory of the server, the database comprising food item type data, cooking appliance data, food item temperature data and doneness data stored in association with cooking set temperature data and cooking duration data, the processor of the server performing a search of the database to determine suggested cooking set temperature and a suggested cooking duration in response to receiving the second inputs; wherein the food item type data, the cooking appliance data, the cooking set temperature data and the cooking duration data populating the database was received from a plurality of devices.

### DRAWINGS

Embodiments of the present application will now be described, by way of example only, with reference to the attached Figures, wherein:

FIG. 1 is a schematic diagram depicting a system for defrosting, heating or cooking a food item according to an embodiment;

FIG. 2 is a schematic diagram of a food item parameter determining device of the system of FIG. 1 according to an embodiment;

FIG. 3 is a flowchart depicting a method of operation of the system of FIG. 1;

FIG. 4 is a flowchart depicting another method of operation of the system of FIG. 1; and

FIG. 5 is a graph depicting a cooking temperature of a food item over time during defrosting, cooking and standing.

### DETAILED DESCRIPTION OF EMBODIMENTS

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein.

There is described herein a system and method of monitoring a temperature of an object. Example objects include: food items, hot tubs, pools, enclosures, buildings such as houses or sheds, wine coolers, refrigerators and freezers. Methods of defrosting, heating or cooking food item objects are described herein by way of example. It will be appreciated by persons skilled in the art that these methods may also be practiced in relation to other types of objects.

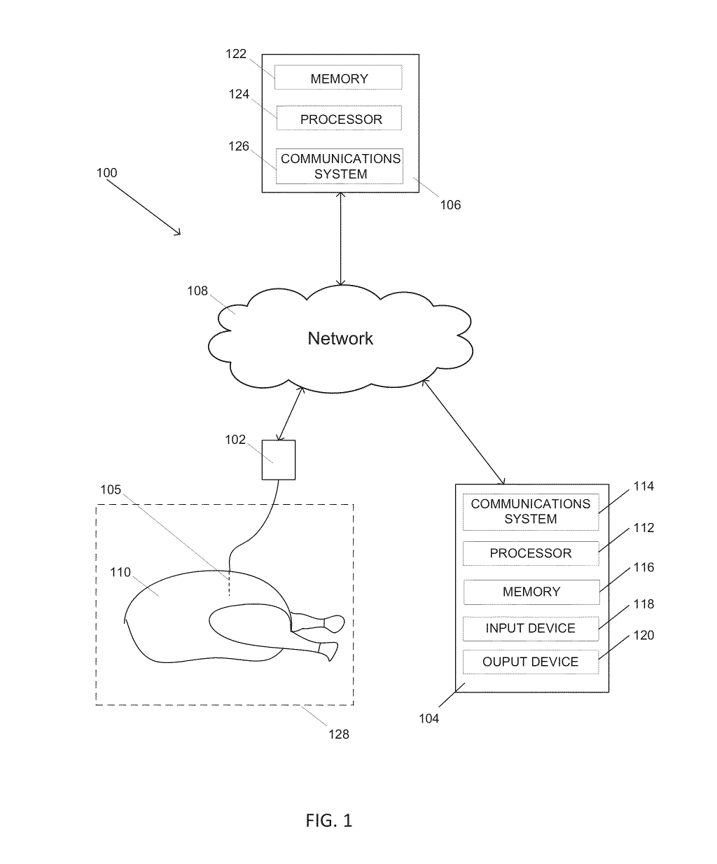

Referring to FIG. 1, a system 100 for defrosting, heating or cooking a food item is generally shown. The system 100 includes a food item parameter determining device 102 in communication with a temperature probe 105 that is inserted into a food item, an electronic device 104 and a server 106. As shown in FIG. 1, the food item 100 may be received in a cooking appliance 128.

Communication between the device 102, the electronic device 104 and the server 106 occurs via a network 108, such as the Internet, for example. The system 100 may alternatively be implemented on a local area network and communication between the device 102, the electronic device 104 and the server 106 may be via wired connections. The local area network may be capable of both wired and wireless communication so that some communication may be wired and some communication may be wireless.

The food item may be any food such as meat, fruit, vegetables, cakes, breads, for example, or combinations thereof. When the food item is meat, the food item type may be any type of meat such as beef, turkey, chicken or lamb, for example.

The food item may be placed on a counter, in a sink, in a sink full of water, or in a refrigerator, for example, during defrosting and may be received in a cooking appliance during heating or cooking. Example cooking appliance types include: an electric oven, a gas oven fueled by liquid propane or natural gas, for example, a convection oven, a smoker, a gas-powered barbecue, an electrical barbecue, a charcoal barbecue, slow cooker or sous vide machine. The cooking appliance may also have a sub-type, such as make, model and year of cooking appliance, for example. The cooking appliance may be open during cooking so that the food item is not fully enclosed in the cooking appliance during cooking.

The term cooking is used herein to refer to any cooking process including: grilling, broiling, smoking, roasting and slow cooking, for example. As described, the system 100 may also be used for defrosting or heating of uncooked and previously cooked food items and re-heating of previously cooked food items.

As will be understood by a person skilled in the art, food items may be cooked to an internal temperature, which is associated with a degree of doneness. For example, meat types have an FDA food-safety recommended minimum internal temperature, such as 165° F. for chicken and turkey. Beef and other red meat types are often cooked to a doneness that is one of: rare, which is associated with an internal temperature of 125° F., medium rare, which is associated with an internal temperature of 135° F., medium, which is associated with an internal temperature of 145° F., medium well, which is associated with an internal temperature of 155° F., and well, which is associated with an internal temperature of 160° F.

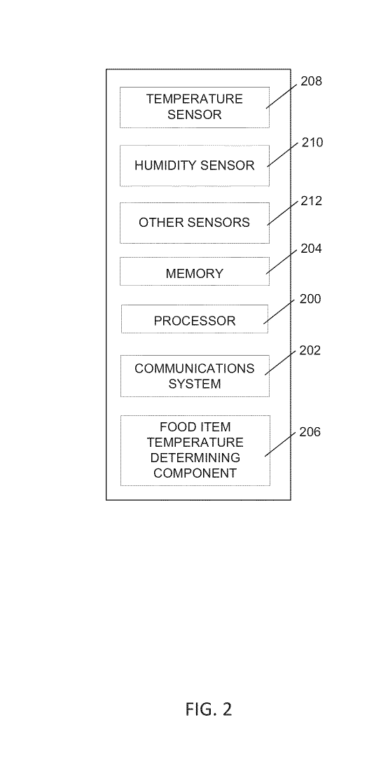

The components of the system of FIG. 1 will now be described. Referring also to FIG. 2, the food item parameter determining device 102 communicates with the temperature probe 105 in order to determine a temperature of the food item 110. Communication between the device 102 and the temperature probe 105 may be via a wireless or a wired connection. The device 102 includes a processor 200 in communication with a memory 204, a communications system 202 and a food item temperature determining component 206, which communicates with the temperature probe 105 in order to determine an internal temperature of a food item. Communication functions including short range communication are performed through the communications system 202. The communications system 202 receives information from and sends information, such as the internal temperature of the food item, to the network 108. The information may be in the form of messages such as HTTP requests, email messages, SMS messages, or social network messages in a format that is usable by Facebook™, Twitter™ and Foursquare™, for example.

Optionally, the device 102 may include a temperature sensor 208, a humidity sensor 210 and other sensors 212 for sensing other parameters relating to the environment of the food item. The other sensors 212 may include a light sensor for detecting flare-ups, a microphone and a vibration sensor, for example. The temperature probe 105 and the sensors for sensing parameters relating to the environment of the food item 208, 210 and 212 may communicate with the device 102 wirelessly or via a wired connection. The temperature sensor 208, the humidity sensor 210 and the other sensors 212 may be housed with the other components of the device 102 or may be remote therefrom.

Referring back to FIG. 1, the electronic device 104 communicates with the device 102 and the server 106 via the network 108. The electronic device 104 may also communicate with the device 102 directly via a Bluetooth™ connection, for example, or through a wired connection. The electronic device 104 may be a desktop computer or may be a portable electronic device 104 such as a mobile, or handheld, wireless communication device such as a cellular phone, a smart-phone, a wireless organizer, a tablet, a laptop computer or a personal digital assistant, for example. Any device that is capable of connecting to the Internet and browsing using a web browser may be used.

The electronic device 104 includes a processor 112 which controls the overall operation of the electronic device 104. Communication functions including short range communication are performed through a communications system 114. Received signals are processed by the communications system 114 and input to the processor 112. The communications system 114 receives information from and sends information to the network 108. The information may be in the form of messages such as HTTP requests, email messages, SMS messages, or social network messages in a format that is usable by Facebook™, Twitter™ and Foursquare™, for example.

The processor 112 further interacts with a memory 116, an input device 118 and an output device 120. The input device 118 may include one or more of: a touch-screen display, a microphone, a keyboard or one or more buttons, for example. The output device 120 may include one or more of: a touch-screen display, a speaker, a vibrating device and a LCD display, for example. The electronic device 104 includes an operating system and software programs that are stored in memory 116 and executed by the processor 122. The electronic device 104 is powered by one or more rechargeable batteries or another power source. As will be understood by a person skilled in the art, the electronic device 104 may include additional components not shown and may include additional functionality not described herein.

The server 106 includes a memory 122, a processor 124 and a communications system 126. The memory 122 may include hard drives in the form of a database. The server 106 may be a stand-alone server or multiple servers in communication with one another. In a multiple server embodiment, processing, storage and communication functions may be shared among the servers. The multiple server embodiment may be understood to be a cloud computing embodiment.

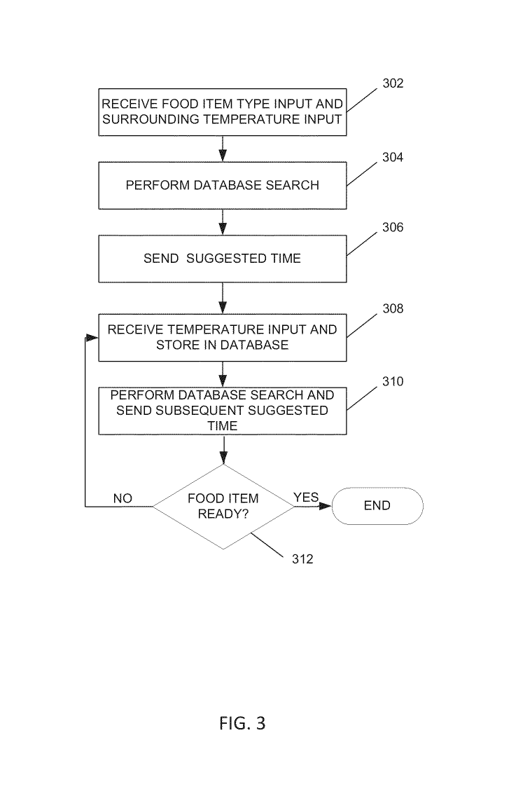

Referring to FIG. 3, a method of defrosting or heating a food item is shown. The steps of FIG. 3 may be carried out by routines or subroutines of software executed by, for example, the processor 124 at the server 106. Coding of software for carrying out such steps is well within the scope of a person of ordinary skill in the art given the present description.

At 302, food item type input and surrounding temperature input are sent from the electronic device 104, received at the server 106 and stored in the database. The food item type and surrounding temperature may be selected by a user using the input device 118 of the electronic device 104. A software application that is executable by the processor 112 may provide a user interface to facilitate selection of the food type and environment. The user interface may include one or more of: menus, drop-down menus, icons, graphs and buttons, for example. The user interface may be configured differently based on the type input of the electronic device 104. For example, electronic device 104 capable of receiving touch input may display icons that are selectable by the user. The surrounding temperature input may alternatively be received from the temperature sensor 208 of the device 102.

At 304, a search of a database is performed. The database is stored at the server 106 and includes food item type data, surrounding temperature data and a time associated with defrosting or heating of a food item. The time may be a duration, an end time calculated based on a start time or a start time calculated based on an end time, for example. At 306, a suggested time is sent from the server 106 to the electronic device 104. At 308, temperature input from the device 102 is received at the server 106. The temperature input corresponds to an internal temperature of the food item. The temperature input is stored in the database in association with the surrounding temperature and food item type in order to be available in subsequent database searches in the present method or in methods performed for food items of other users. At 310, another search of the database is performed and a subsequent suggested time is sent from the server 106 to the electronic device 104. The subsequent suggested time may be generally the same as the suggested duration. The subsequent suggested time may be exactly the same as the suggested duration. At 312, readiness of the food item is determined at the server 106 based on whether or not the temperature input has reached a final temperature, which may be the surrounding temperature. When the food item is not ready, steps 308 and 310 are repeated. When the food item is ready, the method ends.

In an embodiment, information from the device 102 is sent, via the server 106, to the electronic device 104 so that a user may monitor defrosting or heating progress. The information may be in the form of an internal temperature of the food item at a current time or internal temperatures of the food item at more than one time, for example. The information may be in the form of a chart or a graph, for example. The information may alternatively take the form of an alert at the device 102, the electronic device 104 or both the device 102 and the electronic device 104. The alert may indicate a status of the food item, such as defrosting complete or desired heating temperature reached, for example. The alert may be an audible alert, such as a beep, a tone, music or an audio recording, for example, a visible alert, such as a flashing light, a coloured illumination, for example, or an indication of information to be viewed on a display of the electronic device 104. The alert may be sent to the electronic device 104 or another electronic device. The alert may be generated based on receipt of an email message, a text message or social networking message, for example.

In another embodiment, a defrosting or heating history of a user is stored in memory 122 at the server 106. The user may access the defrosting or heating history and mark heating or defrosting events as favorites. Information marked as a favorite may be sent to other electronic devices 104 in response to a user selection, for example.

The method of FIG. 3 may be useful for defrosting a food item. By determining the defrosting time based on extensive data stored in the database, a more accurate defrosting time may be determined. Thus, a likelihood of food poisoning occurring due to the food item having been at too high a temperature for too long may be reduced. In one embodiment, the alert is provided to the user via the electronic device 104 when a set time following a defrosting time has been exceeded in order to advise the user to refrigerate or cook the food item in order to avoid the possible of food poisoning.

In one embodiment, the probe of the device 102 is received in a cavity formed in the frozen food item. The cavity is formed by insertion of a probe shell into the non-frozen food item and subsequent removal of the probe shell from the frozen food item. The probe shell is sized and shaped similar to the probe in order to facilitate insertion of the probe of the device 102 into the frozen food item.

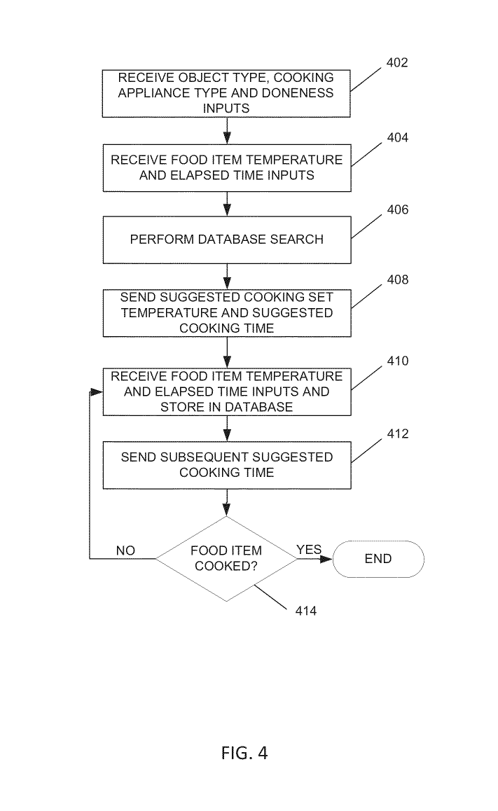

Referring to FIG. 4, a method of cooking a food item is shown. The steps of FIG. 4 may be carried out by routines or subroutines of software executed by, for example, the processor 124 at the server 106. Coding of software for carrying out such steps is well within the scope of a person of ordinary skill in the art given the present description.

At 402, first inputs sent from the electronic device 104 are received by the server 106. The first inputs include: a food item type of a food item to be cooked, a cooking appliance type of a cooking appliance for cooking the food item and doneness. The first inputs are received via a user interface of a software application that is executable by the processor 112. The user interface may include one or more of: menus, drop-down menus, icons, graphs and buttons, for example. The user interface may be configured differently based on the type of input device 118 of the electronic device 104. For example, electronic devices 104 capable of receiving touch input may display icons that are selectable by the user. In an embodiment, a drop-down list that the user uses to select the food item type is sorted based on celebratory events. For example, near Thanksgiving, turkey will be at the top of the drop-down list.

At 404, second inputs are sent from the device 102 and received at the server 106 at a first time. The second inputs include: a temperature of the food item to be cooked and an elapsed cooking time. At 406, a search of a database stored on the server 106 is performed. The database includes food item type data, cooking appliance data and doneness data stored in association with food item temperature data, cooking set temperature data and cooking duration data. At 408, a suggested cooking set temperature and suggested time is sent from the server 106 to the electronic device 104. The suggested time may be a suggested cooking duration, a suggested end time calculated based on a start time or a suggested start time calculated based on an end time. At 410, at a second time following a cooking appliance pre-heating period, the second inputs are sent from the device 102 to the server 106 and the second inputs are stored at the server in association with the food item type, the cooking appliance type and a cooking set temperature. The second inputs are stored in the database in association with the surrounding temperature and food item type in order to be available in subsequent database searches in the present method or in methods performed for food items of other users. At 412, in response to receiving the second inputs, another search is performed in the database and a subsequent suggested cooking time is sent from the server 106 to the electronic device 104. At 414, when the food item is not cooked, steps 410 and 412 are repeated. When the food item is cooked, the method ends.

In an embodiment, the second inputs from the device 102 are sent, directly or via the server 106, to the electronic device 104 so that a user may monitor cooking progress. The second inputs may be in the form of an internal temperature of the food item at a current time or internal temperatures of the food item at more than one time, for example. The information may be in the form of a chart or a graph, for example. The information may alternatively take the form of an alert at the electronic device 104. The alert may indicate a status of the food item, such as doneness reached, doneness exceeded, food item on fire, for example, or may provide instructions to the user such as increase cooking appliance temperature or reduce cooking appliance temperature, for example.

As described in relation to the method of FIG. 3, the alert may be an audible alert, such as a beep, a tone, music or an audio recording, for example, a visible alert, such as a flashing light, a coloured illumination, for example, or an indication of information to be viewed on a display of the electronic device 104 or the device 102. The alert may be sent to the electronic device 104, the device 102 or another electronic device. The alert may be generated based on receipt of an email message, a text message or social networking message, for example.

In another embodiment, a cooking history of a user is stored in memory 122 at the server 106. The user may access the cooking history and mark cooking events as favorites. Information marked as a favorite may be sent to other electronic devices 104 in response to a user selection, for example.

In another embodiment, using the software application, phone numbers and email addresses may be added in order to receive alerts regarding the cooking progress of the food item. Further, dinner party details may be posted on a social networking site, such as Facebook™, for example, directly from the software application.

The method of FIG. 4 increases the likelihood of cooking a food item to a desired doneness on a first try, which may increase cooking confidence of novice cooks. Another advantage of the method of FIG. 4 is that cooking costs may be reduced because fewer overcooked food items will be discarded. In addition, energy costs may be reduced because of a more accurate cooking time being provided.

In addition to the first inputs described, further first inputs may include: geographical origin of food item, position of meat within cooking appliance, geographical location information, atmospheric pressure and elevation above sea level, for example. In addition to the second inputs described, further second inputs may be received from the temperature sensor 208, humidity sensor 210 and other sensors 212 of the device 102.

In an embodiment, the device 102 is integrated into a cooking appliance.

The database used in the defrosting and heating method described herein includes historical data including: food item type data, surrounding temperature data and a time associated with defrosting or heating of a food item. The database used in the cooking method described herein includes historical data including: a food item type of a food item to be cooked, a cooking appliance type of a cooking appliance for cooking the food item, doneness and temperature of the food item during cooking. Other historical data including: geographical origin of food item, position of food item within the cooking appliance, geographical location information, atmospheric pressure elevation above sea level and inputs received from the temperature sensor 208, humidity sensor 210 and other sensors 212 of the device 102 may also be included in the database(s). Further, historical data such as users' ratings of their cooking, heating or defrosting experiences and other user comments may also be stored in the database.

The historical data for defrosting, heating and cooking may be included in a single database or distributed over two or more databases. The databases store historical data for the user of device 102 as well as historical data for users of other devices 102. The historical data may be referred to as crowd-sourced data because it is received from many different users of devices 102. The historical data in the database is appended each time the device 102 is used. The methods described herein use the historical data to improve cooking results for all users. Using this historical data from all users, the suggested time for defrosting or heating, suggested cooking temperature, suggested cooking time, subsequent suggested cooking temperature and subsequent suggested cooking time may be determined based on heuristics, which include interpolation between temperature data in the form of a best-fit polynomial, for example.

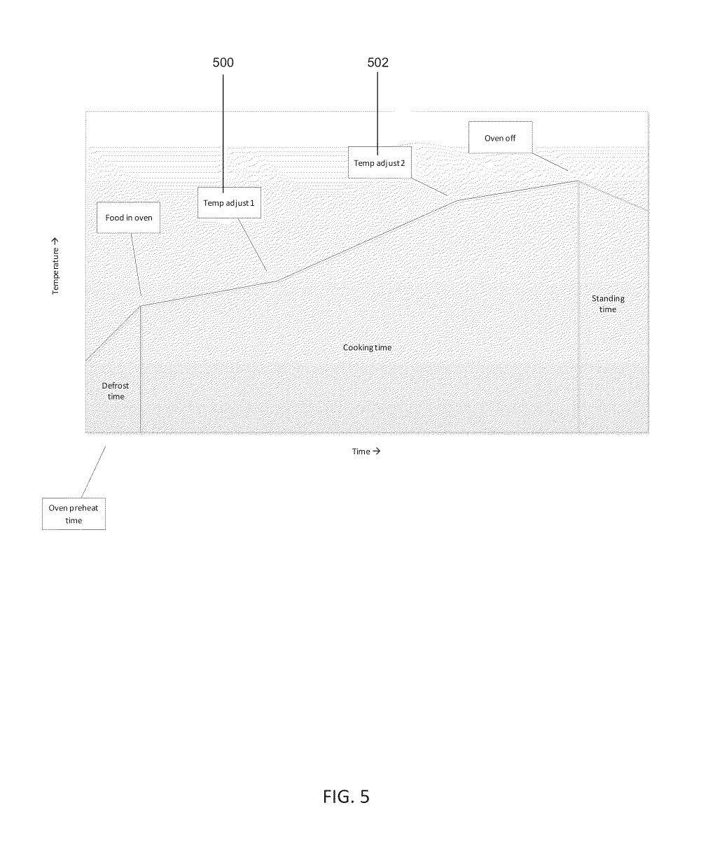

Continued reference is made to FIG. 4 with additional reference to FIG. 5 to describe a method of cooking a food item according to another embodiment. FIG. 5 depicts a cooking cycle of a food item from frozen to cooked. Because the food item is frozen, the method of FIG. 3 may be followed in order to defrost the food item. Once defrosted, first and second inputs are received 402, 404 at the server 106. In this embodiment, the first inputs further include a time of day at which cooking of the food item is to be completed. A database search is then performed 406 and a suggested set temperature and suggested cooking duration are sent 408 from the server to the electronic device 104. In this embodiment, the suggested cooking duration is a suggested time of day at which to put the food item into a pre-heated cooking appliance. At a second time, the second inputs are sent 410 to the server 106 and stored in the database. In response to the receiving the second inputs, another search is performed 412 in the database and a second suggested set temperature is sent from the server 106 to the electronic device 104. The second suggested set temperature is the temperature at which the food item is to be cooked in order for cooking to be finished at the time of day indicated by the user. As shown in FIG. 5, when the second suggested set temperature is different from the current set temperature, the set temperature of the cooking appliance is adjusted manually, or automatically when the cooking appliance is controllable, to the second suggested set temperature, as indicated by reference numeral 500.

When the food item is not cooked 414, at another time, the second inputs are sent 410 to the server 106 and stored in the database. In response to the receiving the second inputs, another search is performed 412 in the database and another suggested set temperature is sent from the server 106 to the electronic device 104. As shown in FIG. 5, when the other suggested set temperature is different from the current set temperature, the set temperature of the cooking appliance is adjusted manually or automatically when the cooking appliance is controllable, to the other suggested set temperature, as indicated by reference numeral 502. The cooking appliance is turned off at the time of day at which cooking of the food item is to be completed. As shown in FIG. 5, the food item may remain in the cooking appliance or may be removed from the cooking appliance for a standing period prior to the food item being served.

In an embodiment, the user may opt out of sending second inputs from the device 102 to the server 106. In this embodiment, the user may use the information in the database when defrosting, heating or cooking but would not share collected temperature and other information.

Another example will be described from the perspective of the user. Day 1: The user takes a turkey out of the freezer, inserts the temperature probe 105 into the probe-receiving cavity formed in the frozen turkey and places the turkey in the sink. The user then launches a software application on the electronic device 104, enters turkey as object type, enters weight of turkey and a done time (for example, Day 2, 5 pm), which accounts for a post-cooking rest period prior to a serving time of 6:00 pm. The software application returns a date and time at which the turkey should be placed in the oven in order to be done at the selected done time (for example, Day 2, 11:10 am). The user leaves the turkey and waits for alerts indicating that the turkey is defrosting. Before going to bed, the user may check the software application and see that the internal temperature of the turkey has increased, however, the turkey has not defrosted.

Day 2: At 8:20 am, the user is alerted via the electronic device 104 that the turkey has thawed to the point that it should be refrigerated. The user refrigerates the turkey. At 10:35 am, the user receives an alert to pre-heat the oven to 450° F. The temperature and time at which the oven should be turned on having been determined based on the crowd-sourced data that is stored in the database, which includes make, model and year of the cooking appliance. At 11:05 am, the user is alerted to put the turkey in the oven and set the temperature to 350° F. Using the software application, the user adds their partner's phone numbers and email addresses of guests attending the dinner party. The user further posts dinner party details as Facebook™ using the software application. The user then leaves the house and becomes engaged in another activity. While away from the house, the user receives an alert that the oven temperature should be adjusted to 325° F. in order to have the turkey done by 5:00 pm (because the user forgot to reduce the temperature to 350° F., when previously alerted). When automatic adjustment is not available for the oven, the user contacts their partner to ask for assistance in adjusting the oven temperature and finds that because their partner received the same alert (or saw the device 102 flashing), their partner had already adjusted the oven temperature. At 3:00 pm, an automatically generated email is sent to the email addresses that were added and a Facebook™ post is generated in order to notify guests that everything is on track for a 6:00 pm dinner time. The user periodically views their electronic device 104 and sees a graph that shows the cooking progress and indicates that cooking is on track. At 4:55 pm, the user receives an alert indicating that the turkey is almost done and should be removed from the oven in 5 minutes. At 5:00 pm, the user is alerted to remove the turkey from the oven, turn off the oven and cover the turkey with tin foil and a tea towel. At 5:55 pm, the user is alerted that it is time to get ready to serve the turkey. At 6:00 pm, the user is alerted to remove the temperature probe 105 from the turkey, clean and store the probe 105 for the next time. A few hours later, the software application requests information regarding how the turkey turned out, such as a doneness rating. The doneness rating is stored in the database and may be posted to Facebook™ and Twitter™, for example.

In general, the information from the device 102 may be stored in the database anonymously, however, volunteered user identification information could be collected and used for targeted advertising, for example. Location information may additionally or alternatively be used to support targeted advertising.

The system and methods described herein have several advantages some of which may have already been discussed. An advantage of using crowd sourced data to improve cooking experiences is that each user's experience will be improved each time the user uses the device 102. The more users that use the device 102, the better the cooking experience becomes for everyone. For example, as new or additional cooking appliances come to market or are used in new ways, the device 102 will adapt in real-time to new cooking methods and appliances. Another advantage of using crowd sourced data is that food items, such as meats, for example, from a particular geographical location may require different cooking parameters in order to deliver the best cooking experience. The methods described herein automatically accommodate for such differences. In general, the apparatus and methods described herein optimize cooking results based on a group of users' previous cooking experiences.

It will be appreciated by a person skilled in the art that although the system and methods presented herein have been described with respect to food items, the system and methods may be used to monitor and adjust the temperature of any object. For example, the temperature probe 105 may be received in a pool and the pool temperature may be adjusted to and then maintained at an optimal temperature using crowd-sourced pool temperature information for different types of pools and different surrounding temperatures.

The above-described embodiments are intended to be examples only. Alterations, modifications and variations can be effected to the particular embodiments by those of skill in the art without departing from the scope of the present application, which is defined solely by the claims appended hereto.

1. A method comprising:
receiving and storing in a database at a server, first inputs comprising: a food item type of a food item to be cooked, a cooking appliance type of a cooking appliance for cooking the food item and a doneness;
receiving and storing in the database at the server at a first time, second inputs comprising: a temperature of the food item;
performing a search of a database stored in a memory of the server, and determining a suggested cooking set temperature and a suggested cooking duration, the database comprising food item type data, cooking appliance data, food item temperature data and doneness data stored in association with cooking set temperature data and cooking duration data;
sending, from the server, a suggested cooking set temperature and a suggested cooking time;
receiving at the server at a later time, the second inputs and storing the second inputs in the database in association with the food item type, the cooking appliance type and the cooking set temperature; and
in response to receiving the second inputs, performing another search of the database and sending, from the server, one of: a subsequent suggested cooking set temperature, a subsequent suggested cooking time and both a subsequent suggested cooking set temperature and a subsequent suggested cooking time;
wherein the food item type data, the cooking appliance data, the cooking set temperature data and the cooking duration data of the database were received from a plurality of devices.

2. The method of claim 1, wherein the food item type data, the cooking appliance data, the cooking set temperature data and the cooking duration data was received wirelessly from the devices via a wireless network.

3. The method of claim 1, wherein the food type is one of: meat, fruit, vegetables, cakes and breads, for example.

4. The method of claim 1, wherein the cooking appliance type is one of: an electric oven, a gas oven fueled by liquid propane or natural gas, for example, a convection oven, a smoker, a gas-powered barbecue, an electrical barbecue, a charcoal barbecue, slow cooker and a sous vide machine.

5. The method of claim 1, wherein the suggested cooking time is one of: a duration, an end time calculated based on a start time and a start time calculated based on an end time.

6. The method of claim 1, wherein the suggested cooking time is a time of day at which the meat to be cooked should be finished cooking.

7. The method of claim 5, wherein the suggested cooking time is a time of day at which the meat to be cooked should be put in the cooking appliance in order to be cooked by an end time.

8. The method of claim 1, wherein the suggested set temperature is determined by interpolation or extrapolation of cooking set temperature data stored in the database.

9. The method of claim 1, wherein the suggested cooking duration data is determined by interpolation or extrapolation of cooking duration data stored in the database.

10. The method of claim 1, wherein the first inputs comprise one of: geographical origin of food item, position of meat within cooking appliance, geographical location information, atmospheric pressure and elevation above sea level.

11. The method of claim 1, wherein the second inputs comprise input from one of: a humidity sensor, a temperature sensor for sensing a temperature of an environment, a light sensor, a microphone and a vibration sensor.

12. The method of claim 1, comprising sending, from the server, an output indicating a cooking progress of the food item.

13. The method of claim 1, comprising sending, from the server, an alert to indicate a status of the food item.

14. The method of claim 1, wherein the cooking appliance automatically adjusts the cooking set temperature.

15. The method of claim 1, wherein one or both of: the subsequent suggested cooking set temperature and the suggested cooking set temperature and the subsequent suggested cooking time and the suggested cooking time are different.

16. A non-transitory computer-readable medium comprising instructions executable on a processor of the server for implementing the method of claim 1.

17. A method of defrosting or heating a food item comprising:
receiving, at a processor of a server, first inputs comprising a food item type and a surrounding temperature;
receiving at the processor, second inputs comprising: a temperature of the food item, and storing the temperature of the food item in the database in association with the food item type, and the surrounding temperature;
performing a search of a database stored in a memory of the server, and determining a suggested time, the database comprising food item type data stored in association with room temperature data, food item temperature data and duration data;
sending, from the server, the suggested time;
wherein the food item type data, surrounding temperature data, and duration data of the database were received from a plurality of devices, the devices having wireless communication capability.

18. The method of claim 17, wherein the food item type data, the surrounding temperature data and the duration data was received wirelessly from the devices via a wireless network.

19. The method of claim 17, wherein the temperature of the food item is received via a temperature probe received in a pre-formed cavity when the food item is frozen.

20. A non-transitory computer-readable medium comprising instructions executable on a processor of the server for implementing the method of claim 17.

21. A method of monitoring and adjusting a temperature of an object comprising:
receiving, at a processor of an electronic device, an object type, a current temperature of the object and a type of heating or cooling device;
sending the object type, the current temperature of the object and the type of heating or cooling device to a server, the object type, the current temperature of the object and the type of heating or cooling device being stored on the server; and
receiving, at the processor of the electronic device, a suggested set temperature for the heating or cooling device to achieve a suggested final temperature for the object type.

22. A system for monitoring and adjusting a temperature of an object comprising:
a portable electronic device for receiving first inputs comprising: a food item type of a food item to be cooked, a cooking appliance type of a cooking appliance for cooking the food item and a doneness, the portable electronic device for sending the first inputs to a server;
a temperature probe in communication with the portable electronic device, the temperature probe generating second inputs comprising a temperature of the food item, the temperature probe sending the second inputs to the server at more than one time over a cooking duration;
a database stored in a memory of the server, the database comprising food item type data, cooking appliance data, food item temperature data and doneness data stored in association with cooking set temperature data and cooking duration data, the processor of the server performing a search of the database to determine suggested cooking set temperature and a suggested cooking duration in response to receiving the second inputs;
wherein the food item type data, the cooking appliance data, the cooking set temperature data and the cooking duration data populating the database was received from a plurality of devices.
